(19) United States
(12) Patent Application Publication
(10) Pub. No.: US 2025/0388166 A1
(43) Pub. Date: Dec. 25, 2025

(54) OPTICAL CENTER AIMING

(71) Applicant: Ford Global Technologies, LLC, Dearborn, MI (US)

(72) Inventors: Jason Michael Babbage, Allen Park, MI (US); Matthew W. Roosen, Memphis, MI (US); Venkatesh Krishnan, Canton, MI (US); Ryan Nicholas Garvey, Livonia, MI (US); William Clay Priddy, Clarkson, KY (US)

(21) Appl. No.: 18/751,577

(22) Filed: Jun. 24, 2024

(51) Int. Cl. B60Q 1/04; G01B 11/06

(52) U.S. Cl. CPC B60Q 1/045; G01B 11/0608

(57) ABSTRACT

A system and method include measuring at least one front fender characteristic and determining an optical center as a reference target for a headlamp based on the at least one front fender characteristic. Additionally, an aim bias based on the optical center is determined, and headlamp aim is adjusted to a final aim target based on the aim bias.

### TECHNICAL FIELD

This disclosure relates generally to determining an optical center for a headlamp based on an individually measured front fender characteristic, which is then used to adjust headlamp aim.

### BACKGROUND

Vehicles include many different types of lamp assemblies, such as headlamps for example. These lamps must be adjusted during assembly of the vehicle to ensure that the aim of the lamps is within a specified target range.

### SUMMARY

A method according to an exemplary aspect of the present disclosure includes, among other things: measuring at least one front fender characteristic; determining an optical center as a reference target for a headlamp based on the at least one front fender characteristic; determining an aim bias based on the optical center; and adjusting headlamp aim to a final aim target based on the aim bias.

In a further non-limiting embodiment of any method, the method includes adjusting the headlamp aim to a vertical target and a horizontal target that is a predetermined distance from a front of a vehicle.

In a further non-limiting embodiment of any method, the predetermined distance is approximately twenty-five feet.

In a further non-limiting embodiment of any method, the at least one front fender characteristic comprises at least a measured distance from ground to an uppermost point of a wheel arch of a front fender.

In a further non-limiting embodiment of any method, the method includes using a ride height measurement device to measure the measured distance.

In a further non-limiting embodiment of any method, the ride height measurement device comprises at least one camera.

In a further non-limiting embodiment of any method, at least one camera comprises a plurality of cameras, and the method includes: measuring a first wheel alignment characteristic with a fore wheel camera of the plurality of cameras; measuring a second wheel alignment characteristic with an aft wheel camera of the plurality of cameras; measuring a third wheel alignment characteristic with a wheel camber camera of the plurality of cameras; and measuring vehicle ride height at the uppermost point of the wheel arch with a ride height camera.

In a further non-limiting embodiment of any method, the step of determining the optical center for the headlamp includes: determining a vehicle specific distance from the uppermost point of the wheel arch to an designed optical center of an associated vehicle; and adding the vehicle specific distance to the measured distance to determine the optical center as a target optical center.

In a further non-limiting embodiment of any method, the vehicle specific distance comprises an input that is a predetermined value that is unique to each vehicle, and wherein the measured distance is measured for each vehicle prior to adjusting the headlamp aim.

In a further non-limiting embodiment of any method, the method includes using the ride height measurement device to position the headlamp at the target optical center determined based on the vehicle specific distance and the measured distance, and subsequently adjusting the headlamp aim to the final aim target based on the aim bias.

In a further non-limiting embodiment of any method, the aim bias comprises an aim specification that is based on predetermined vehicle characteristics and a measured ride height characteristic.

In a further non-limiting embodiment of any method, the method includes measuring the measured distance for a front right fender and a front left fender.

In a further non-limiting embodiment of any method, the headlamp comprises a front right headlamp and a front left headlamp, and the method includes adjusting aim for the front right headlamp based on the measured distance for the front right fender and adjusting aim for the front left headlamp based on the measured distance for the front left fender.

A system according to an exemplary aspect of the present disclosure includes, among other things: a measurement device that measures at least one front fender characteristic; and one or more controllers that are configured to determine an optical center as a reference target for a headlamp based on the at least one front fender characteristic; determine an aim bias based on the optical center; and adjust headlamp aim to a final aim target based on the aim bias.

In a further non-limiting embodiment of any system, the headlamp aim is adjustable to a vertical target and a horizontal target that is a predetermined distance from a front of a vehicle.

In a further non-limiting embodiment of any system, the measurement device comprises a ride height measurement device, and wherein the at least one front fender characteristic comprises at least a measured distance from ground level to an uppermost point of a wheel arch of a front fender.

In a further non-limiting embodiment of any system, the ride height measurement device comprises a plurality of cameras, and including: measuring a first wheel alignment characteristic with a fore wheel camera of the plurality of cameras; measuring a second wheel alignment characteristic with an aft wheel camera of the plurality of cameras; measuring a third wheel alignment characteristic with a wheel camber camera of the plurality of cameras; and measuring vehicle ride height at the uppermost point of the wheel arch with a ride height camera.

In a further non-limiting embodiment of any system, the ride height measurement device measures the measured distance for a front right fender and a front left fender, and wherein the one or more controllers are configured to adjust aim for a front right headlamp based on the measured distance for the front right fender and adjust aim for a front left headlamp based on the measured distance for the front left fender.

In a further non-limiting embodiment of any system, the optical center is determined based on a summation of the measured distance and a vehicle specific distance from the uppermost point of the wheel arch to a designed optical center of the headlamp of an associated vehicle, and wherein the vehicle specific distance comprises an input that is a predetermined value that is unique to each vehicle, and wherein the measured distance is measured for each vehicle prior to adjusting the headlamp aim.

In a further non-limiting embodiment of any system, the predetermined distance is approximately twenty-five feet.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of a vehicle.

FIG. 2 is a front view of a measurement device.

FIG. 3 is a schematic illustration of adjustment of headlamps to an aim height/angle at a predetermined distance from a front of the vehicle.

### DETAILED DESCRIPTION

This disclosure details a system and method for determining an optical center for a headlamp based on an individually measured front fender characteristic, which is then used to adjust headlamp aim.

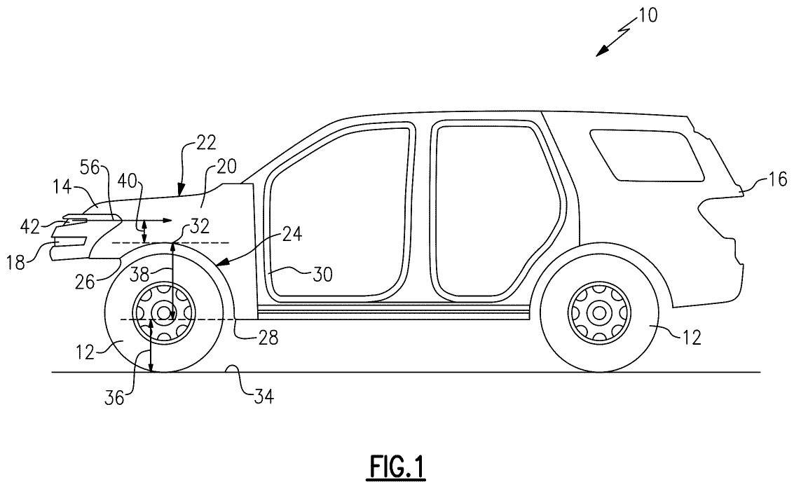

With reference to FIG. 1, a vehicle 10 is supported by a plurality of wheels 12 and extends from a front end 14 to a rear end 16. Headlamps 18 (FIGS. 1 and 3) are located at the front end 14 of the vehicle 10. The vehicle 10 includes a front fender 20 at each side that extends downwardly from a hood 22, and which also extends around the associated wheel 12. Each fender 20 has an arch 24 that extends in a direction along a length of the vehicle, e.g., a longitudinal direction, from a front fender end 26 near the headlamp 18 to a rear fender end 28 near an occupant door opening 30.

In one example, the arch 24 comprises a curvature, e.g., a curved surface, that extends from the front fender end 26 to the rear fender end 28. In implementations, the rear fender end 28 defines a lowest point of the arch 24 and an uppermost point 32 of the arch 24 is a distance that is furthest from ground level 34. In some implementations, a first dimension 36 is measured from ground level 34 to the lowest-most point of the arch 24 at the rear fender end 28, and a second distance 38 is measured from the lowest-most point of the arch 24 to the uppermost point 32 of the arch 24, e.g., an arch height. In some implementations, the arch height may be measured as a single dimension. A third dimension 40 is a known distance from the uppermost point 32 of the arch 24 to a known optical center location 42 of the headlamp 18. A fourth dimension 56 is a fore/aft distance from the known optical center location 42 to the uppermost point 32 of the arch 24.

The subject disclosure provides a system and method for measuring at least one front fender characteristic; determining an optical center as a reference target for an associated headlamp based on the at least one front fender characteristic; applying a specified aim bias based on the optical center; and adjusting headlamp aim to a final aim target relative to optical center based on the aim bias.

Current aiming and audit systems in manufacturing plants have limitations due to using a floor-up aiming technique, which creates vehicle styles that are divided into aim plus ride height groups. In certain applications, headlamp aim is adjusted to a standard specification at a location that is twenty-five feet from the front end 14 of the vehicle 10. Dividing vehicle styles into groups may cause reduced capability as there can be multiple ride heights within a style group having to meet a single aim specification using floor-up aiming.

The subject system and method measures headlamp center and aiming from the optical center down, which allows for the elimination of using the floor-up aiming technique. In implementations, variables that would drive style count would be the headlamp type and headlamp center versus a fender arch position relationship, which allows for headlamps of a specific type plus a specific fender type to be aimed to the same measured headlamp center with an aim bias target. This would significantly reduce complexity and simplify the aiming process.

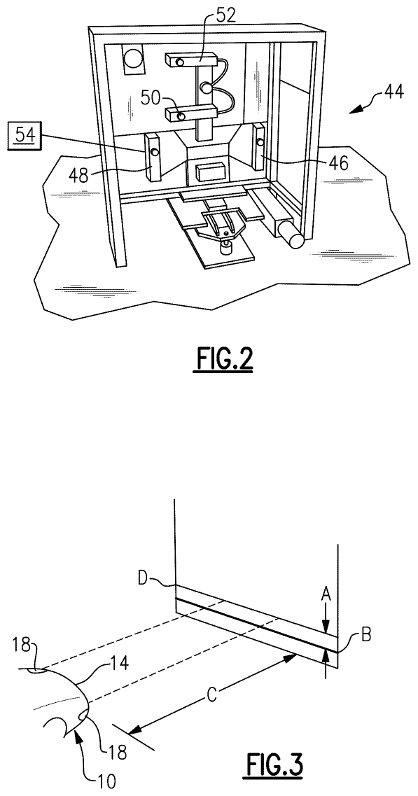

FIG. 2 shows one example of a measurement device 44 used in a manufacturing plant to make various wheel measurements. In one example, the measurement device 44 comprises a ride height measurement device used at a wheel alignment and headlamp aiming station. In implementations, the measurement device 44 comprises at least: a first camera 46 that comprises a fore wheel camera that measures a first wheel alignment characteristic; a second camera 48 that comprises an aft wheel camera that measures a second wheel alignment characteristic; a third camera 50 that comprises a wheel camber camera that measures a third wheel alignment characteristic; and a fourth camera 52 that comprises a vehicle ride height measurement camera that measures ride height at the fender arch/wheel lip (32 of FIG. 1) for headlamp aiming.

In implementations, the disclosed system and method utilizes dimensions from the fender height measurement device in combination with a known fender versus headlamp designed relationship to calculate the optical center of the headlamp 18 that will be used as a reference point for a final aim target, per each individual vehicle 10. In one example, one or more controllers 54 are associated with the measurement device 44. The one or more controllers 54 receive measurement data and have access to stored data and vehicle design characteristics, which are used to calculate the reference point for the final aim target.

In implementations, the one or more controllers 54 may include a processor, memory, and one or more input and/or output (I/O) device interface(s) that are communicatively coupled via a local interface. The local interface can include, for example but not limited to, one or more buses and/or other wired or wireless connections. The controller 54 may be a hardware device for executing software, particularly software stored in memory. The controller 54 can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The software in the memory may include one or more separate programs, each of which includes an ordered listing of executable instructions for implementing logical functions. Any of various Input/Output devices may be coupled to system I/O interface(s). The controller 54 can be configured to execute software stored within the memory, to communicate data to and from the memory, and to generally control operations of the computing device pursuant to the software. Software in memory, in whole or in part, is read by the processor, perhaps buffered within the processor, and then executed.

As shown in FIG. 3, the system controller 54 calculates optical centers of right hand and left hand headlamps 18 using the ride height measurement device 44 regarding fender measurements. The aim is set for a predetermined distance (C) from the front end 14 of the vehicle. In this example, the predetermined distance (C) is twenty-five feet. In other examples, other predetermined distances may be used dependent on other aiming specifications. An average calculated optical center (D) is used as an optical center height for both headlamps 18, e.g., the reference target point, for the vehicle 10 to execute a symmetric aim. The headlamp aim is thus adjusted to a vertical target and a horizontal target that is at the predetermined distance. In this example, an aim bias (A) is calculated from design requirements by determining the best headlamp aim for performance from the optical center height (D) to get a desired aim cutoff target (B). This aim bias (A) is subtracted from the calculated optical center (D) to arrive at the final aim target (B). In implementations, the adjustment may be adjusting aim downwards at a determined angle from the reference target level to the adjusted final target level.

In implementations, inputs to the system include at least a pre-defined optical center of each type of vehicle headlamp; a distance between an uppermost portion of a fender wheel arch and the optical center; and headlamp aim specification with calculations based on the headlamp optical center. In implementations, each headlamp is comprised of a plurality of LED lights and the optical center is calculated based on the plurality of LED lights together. Those skilled in the art who have the benefit of this description will be able to determine the optical center that would be applied for these purposes. The distance between an uppermost portion of a fender wheel arch and the determined optical center is a known value for each type of vehicle design configuration.

In one example, each vehicle would enter an aiming station within a manufacturing facility where the associated inputs described above would be identified for that vehicle. Thus, vehicle type, lamp type, and defined front X/Z fender geometry constants would be identified for that vehicle. As known, the X direction refers to a direction along a length of a vehicle, the Y direction refers to a direction along a width of the vehicle, and the Z direction refers to a direction along a height of the vehicle.

Next, the measurement device 44 measures defined vehicle characteristics and then utilizes the defined vehicle geometry to calculate the vertical and horizontal coordinates of the headlamp center position. For example, the measurement device 44 uses the fourth camera 52 to measure front fender ground to wheel arch dimensions for each side, and then the controller 54 calculates the headlamp optical center position in Y/Z directions based on the known geometry design constants for that vehicle type.

The measurement device 44 then positions itself to a horizontal coordinate (Y) (considered a constant from a vehicle center) and to the calculated (Z) vertical coordinate. In implementations, this Y/Z position comprises a reference target point.

Next, the system determines vertical and horizontal nominal target position per headlamp using the system inputs and the measured geometry. In one example, the system calculates the vertical and horizontal nominal target for that type of vehicle by applying a given aim bias value to the calculated vertical lamp center position (Z), e.g. the target point, to determine the nominal vertical aim target. The nominal horizontal target is a constant Y value by vehicle type and a constant distance from the vehicle center.

Finally, an operator and/or equipment is used to adjust the headlamps to the calculated vertical (Z) and horizontal (Y) target. For example, the headlamps are adjusted at their vertical cutoff to the calculated V and H final targets.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method, comprising:
measuring at least one front fender characteristic;
determining an optical center as a reference target for a headlamp based on the at least one front fender characteristic;
determining an aim bias based on the optical center; and
adjusting headlamp aim to a final aim target based on the aim bias.

2. The method according to claim 1, including adjusting the headlamp aim to a vertical target and a horizontal target that is a predetermined distance from a front of a vehicle.

3. The method according to claim 2, wherein the predetermined distance is approximately twenty-five feet.

4. The method according to claim 1, wherein the at least one front fender characteristic comprises at least a measured distance from ground to an uppermost point of a wheel arch of a front fender.

5. The method according to claim 4, including using a ride height measurement device to measure the measured distance.

6. The method according to claim 5, wherein the ride height measurement device comprises at least one camera.

7. The method according to claim 6, wherein at least one camera comprises a plurality of cameras, and including:
measuring a first wheel alignment characteristic with a fore wheel camera of the plurality of cameras;
measuring a second wheel alignment characteristic with an aft wheel camera of the plurality of cameras;
measuring a third wheel alignment characteristic with a wheel camber camera of the plurality of cameras; and
measuring vehicle ride height at the uppermost point of the wheel arch with a ride height camera.

8. The method according to claim 5, wherein determining the optical center for the headlamp includes:
determining a vehicle specific distance from the uppermost point of the wheel arch to an designed optical center of an associated vehicle; and
adding the vehicle specific distance to the measured distance to determine the optical center as a target optical center.

9. The method according to claim 8, wherein the vehicle specific distance comprises an input that is a predetermined value that is unique to each vehicle, and wherein the measured distance is measured for each vehicle prior to adjusting the headlamp aim.

10. The method according to claim 9, including using the ride height measurement device to position the headlamp at the target optical center determined based on the vehicle specific distance and the measured distance, and subsequently adjusting the headlamp aim to the final aim target based on the aim bias.

11. The method according to claim 10, wherein the aim bias comprises an aim specification that is based on predetermined vehicle characteristics and a measured ride height characteristic.

12. The method according to claim 5, including measuring the measured distance for a front right fender and a front left fender.

13. The method according to claim 12, wherein the headlamp comprises a front right headlamp and a front left headlamp, and including adjusting aim for the front right headlamp based on the measured distance for the front right fender and adjusting aim for the front left headlamp based on the measured distance for the front left fender.

14. A system comprising:
a measurement device that measures at least one front fender characteristic; and
one or more controllers that are configured to
determine an optical center as a reference target for a headlamp based on the at least one front fender characteristic;
determine an aim bias based on the optical center; and
adjust headlamp aim to a final aim target based on the aim bias.

15. The system of claim 14, wherein the headlamp aim is adjustable to a vertical target and a horizontal target that is a predetermined distance from a front of a vehicle.

16. The system according to claim 15, wherein the measurement device comprises a ride height measurement device, and wherein the at least one front fender characteristic comprises at least a measured distance from ground level to an uppermost point of a wheel arch of a front fender.

17. The system according to claim 16, wherein the ride height measurement device comprises a plurality of cameras, and including:
measuring a first wheel alignment characteristic with a fore wheel camera of the plurality of cameras;
measuring a second wheel alignment characteristic with an aft wheel camera of the plurality of cameras;
measuring a third wheel alignment characteristic with a wheel camber camera of the plurality of cameras; and
measuring vehicle ride height at the uppermost point of the wheel arch with a ride height camera.

18. The system according to claim 16, wherein the ride height measurement device measures the measured distance for a front right fender and a front left fender, and wherein the one or more controllers are configured to adjust aim for a front right headlamp based on the measured distance for the front right fender and adjust aim for a front left headlamp based on the measured distance for the front left fender.

19. The system according to claim 16, wherein the optical center is determined based on a summation of the measured distance and a vehicle specific distance from the uppermost point of the wheel arch to a designed optical center of the headlamp of an associated vehicle, and wherein the vehicle specific distance comprises an input that is a predetermined value that is unique to each vehicle, and wherein the measured distance is measured for each vehicle prior to adjusting the headlamp aim.

20. The system according to claim 15, wherein the predetermined distance is approximately twenty-five feet.
